(19) United States
(12) Patent Application Publication
(10) Pub. No.: US 2007/0101432 A1
(43) Pub. Date: May 3, 2007

(54) Risk driven compliance management

(75) Inventor: Matthew Chase Carpenter, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/261,091

(22) Filed: Oct. 28, 2005

(51) Int. Cl. G06F 11/00

(52) U.S. Cl. 726/25

(57) ABSTRACT

Environmental risk levels are leveraged to provide dynamic, user-tailorable, actions to detect network compliance and/or to remediate via manual and/or automatic means to bring the network into compliance given the risk level. The risk levels can be based on a combination of business, security, and operation factors and the like. Potentially different remediation steps can be performed on a network-wide basis and/or on individual items of the network based on a current level of environmental risk. Instances can include a management console that can provide a centralized point of administration that allows an organization to review a state of compliance with a security policy across a network environment and/or select a current level of risk which can drive a configuration management engine appropriately. The configuration management engine can utilize existing components to facilitate in detection and/or remediation of the computer network.

### BACKGROUND

Computer networks have become an integral and pervasive part of business, government, and other organizations. The advent of the Internet has also greatly expanded the reliance of networks to the level of individual users who log onto the Internet at home and at other locations. It is becoming increasingly rare to find computing devices that do not utilize networks in some fashion. Networks can provide infinite data resources and connectivity to almost any point in the world. Additionally, the speed and efficiency afforded by networks have made them an almost indispensable necessity to almost any venture, whether big or small. As a result, the number of computer users has grown as well as the scale and complexity of the networks that support them. This increased complexity has also caused the number and complexity of problems associated with networks to increase.

The reliance on networking is justified because of the enormous benefits, but, at the same time, heavy reliance on a specific type of technology can also leave users vulnerable should the technology fail. Failures can occur for a multitude of reasons such as malfunctioning network support equipment, improper setup of network protocols, and poorly secured network, etc. The internal factors such as equipment failures can be remedied by higher quality equipment. To facilitate a truly secure environment, this remedy along with a thorough configuration auditing process and a workable security plan are generally necessary to protect complex networks from attacks. One of the most challenging aspects of securing a network is that the ‘threat’ can change over time or by location (e.g., as a user moves their mobile computing device from a trusted location to an untrusted location and back, etc.). And the only constant appears to be that the level of the threat is ever changing.

In a simplistic thought process, it seems that the best solution is to always provide maximum security for a network. However, typically, these types of solutions hamper network users in some fashion—often security and usability or functionality are at opposite ends of a spectrum. The interference can be slight, such as requiring a password for every log in or transaction, to extremely burdensome, such as requiring that users never log into the network remotely and must be physically present at a secured computing device in order to utilize the network. Most businesses cannot operate in the latter fashion for any period of time. It would prove too burdensome, and it is generally unnecessary a majority of the time when the risk of a threat is low.

In order to circumvent such activity as malicious attacks and other inadvertent security risks to the network, compliance procedures are generally put in place. The compliance procedure dictates what should be done so that the machines on a network are within ‘compliance’ of a guideline or security policy. Typically, this requires someone to review the security policy and implement it within the network. As the complexity of the networks has grown, this has become an extremely burdensome task that, in some situations, cannot be done efficiently. Compliance software applications were developed to assist in determining if all required or suggested guidelines were implemented in a network. An assessment of the vulnerability of the network environment could also be made based upon the level of compliance detected by the applications. This allows the network maintainer to implement changes to the components of the network to facilitate in protecting it.

Unfortunately, like most manual tasks, they become increasingly difficult to perform as the rate and quantity of required changes increases and as threats constantly evolve. Thus, if a new risk to the network develops and requires additional password protections to be implemented along with an additional virus scan aimed at a particular virus type, this situation could probably be handled by the maintainer in a timely fashion. However, if the maintainer was responsible for a worldwide network or thousands of new threats appeared within a few hours, the maintainer would not be able to take the necessary steps in a timely manner to adequately protect the network, leaving the network extremely vulnerable. Even if the network maintainer can make the necessary changes, the potential impact of the remediations may have unseen negative effects on the network. As the threat level changed, the level of risk to the network increased, necessitating that the compliance and remediation procedure change also. A new compliance procedure, if implemented in time, might have facilitated in preventing the network threats from damaging the network.

### SUMMARY

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

The subject matter relates generally to network risk management, and more particularly to systems and methods for dynamically managing risk compliance for a computer network environment in response to a risk level. Environmental risk levels are leveraged to provide dynamic, user-tailorable, actions to detect network compliance and/or to remediate via manual and/or automatic means to bring the network into compliance given a risk level. The risk level can be, for example, based on a combination of business, security, and operation factors and the like. Potentially different remediation steps can be performed manually and/or automatically on a network-wide basis and/or on individual items of the network based on the current level of environmental risk. Instances can include a management console that can provide a centralized point of administration that allows an organization to review a state of compliance with a security policy across a network environment and/or select a current level of risk which can drive a configuration management engine appropriately. Other instances can include a hierarchy of management consoles for a number of network environments, providing a scalable means to centrally manage risk compliance on a large scale. The configuration management engine can utilize existing components to facilitate in detection and/or remediation of the computer network. Reports and/or workflows can also be generated to facilitate in manually configuring and/or remedying the network and/or to facilitate in monitoring risk levels.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of a risk driven compliance system in accordance with an aspect of an embodiment.

FIG. 2 is another block diagram of a risk driven compliance system in accordance with an aspect of an embodiment.

FIG. 3 is an example of dynamic risk compliance parameters in accordance with an aspect of an embodiment.

FIG. 4 is a block diagram of a risk driven compliance system interacting with a computer network environment in accordance with an aspect of an embodiment.

FIG. 5 is another block diagram of a risk driven compliance system interacting with a computer network environment in accordance with an aspect of an embodiment.

FIG. 6 is an illustration of an example system architecture for a risk driven compliance system in accordance with an aspect of an embodiment.

FIG. 7 is a flow diagram of a method of facilitating risk driven compliance in accordance with an aspect of an embodiment.

FIG. 8 is another flow diagram of a method of facilitating risk driven compliance in accordance with an aspect of an embodiment.

FIG. 9 is yet another flow diagram of a method of facilitating risk driven compliance in accordance with an aspect of an embodiment.

FIG. 10 illustrates an example operating environment in which an embodiment can function.

FIG. 11 illustrates another example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

The systems and methods herein provide risk driven compliance management techniques that allow for a dynamic level of scanning and compliance based on the amount of risk in an organization at any given time. By defining levels of risk that are determined by a combination of business, security, and/or operational information, a compliance management system can be provided that scans for and potentially remediates different items based on a current acceptable level of risk. Solutions that provide compliance checking today typically offer only one level of complexity and depth of scanning. This adds extra processing time and complexity to the process. Most scans include a large number of checks that are only required in rare cases. By allowing for a sliding scale of checks and remediations, the systems and methods herein can reduce the number of false positives. This allows security operations teams to focus on the problems most associated with the risks at hand instead of wasting time investigating non-problems.

For example, as a company operates on a day-to-day basis, it may have a low risk level (level 1 or green). At this point, it can scan machines on the network and evaluate a minimal set of both configuration settings and security settings. This level of risk can provide the flexibility not to automatically remediate any setting or misconfiguration, but, instead, to inform the necessary personnel of changes that need to be made and provide an automated workflow to allow them to make these changes easily. As the risk level in the environment increases, the number of checks can increase, and the remediation can be made automatic. For example, in a high risk situation (e.g., a worm/virus outbreak), a compliance management engine can scan, not only for necessary patches, but also automatically apply the necessary ones to prevent computing devices from becoming infected. Additionally, it can, for example, run a scan automatically to remove any viruses from potentially infected systems. Thus, on a “normal” day, users can delay upgrading a security feature, but on a day when there is a serious threat on the Web, for example, the risk driven compliance systems and methods can force a signature download, etc.

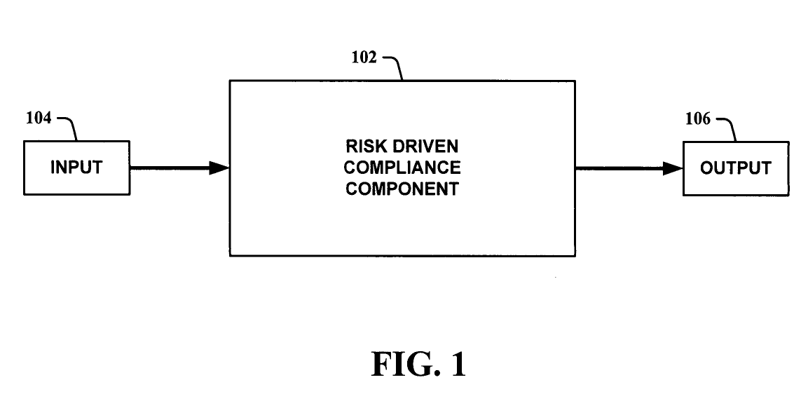

In FIG. 1, a block diagram of a risk driven compliance system 100 in accordance with an aspect of an embodiment is shown. The risk driven compliance system 100 is comprised of a risk driven compliance component 102 that receives an input 104 and provides an output 106. The input 104 is typically a risk level that is derived for a computer network environment. The risk level can be based on a combination of business, security, operational, and/or other types of information that relate to and/or affect the computer network environment in some capacity. The risk level can be directly obtained from a source that assesses risk and/or it can be derived in whole and/or in part via the risk driven compliance system 100. The risk driven compliance component 102 provides for a dynamic level of detection and/or compliance based on the amount of risk of the input 104 for the environment at any given time. This allows the risk driven compliance component 102 to detect and/or remediate different items of the environment based on a current acceptable level of risk.

This is in sharp contrast to systems today that can offer only a single level of complexity and depth of detection. Thus, the risk driven compliance component 102 provides an output 106 that is comprised of information and/or controls that facilitate a user (e.g., network security administrator) and/or a compliance engine in dynamically responding to a risk level to protect a computer network environment. In other instances the output 106 can also be comprised of detection and/or remediation information and/or controls that can be directly applied to the computer network environment to bring it into compliance in response to the risk level provided by the input 104. The risk driven compliance component 102 is flexible in its implementation to afford both compliance management and/or direct compliance control of a computer network environment. This allows the risk driven compliance system 100 to be employed and/or integrated into different environments with various levels of existing compliance components.

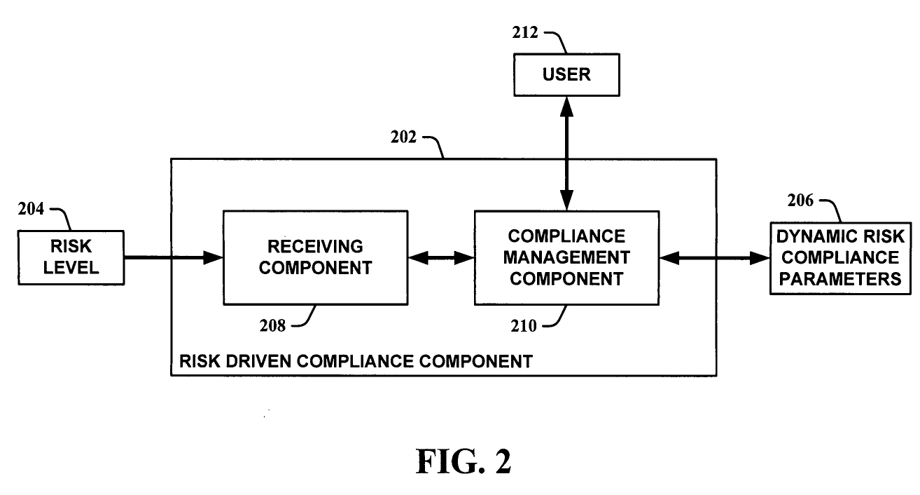

Turning to FIG. 2, another block diagram of a risk driven compliance system 200 in accordance with an aspect of an embodiment is depicted. The risk driven compliance system 200 is comprised of a risk driven compliance component 202 that obtains a risk level 204 and provides dynamic risk compliance parameters 206. The risk driven compliance component 202 is comprised of a receiving component 208 and a compliance management component 210 that interfaces with a user 212. The receiving component 208 obtains the risk level 204 from various sources as described supra (e.g., directly supplied by a risk assessing source, risk information that is compiled by the receiving component 208, risk information that is augmented by the receiving component 208, etc.).

The compliance management component 210 utilizes the risk level 204 from the receiving component 208 to dynamically manage a computer network environment by providing the dynamic risk compliance parameters 206. The compliance management component 210 typically includes a user interface such as, for example, a compliance management console and the like to allow the user 212 to review risk compliance information for data reasons and/or to facilitate in manually bringing a computer network environment and/or an environment item into compliance and/or to facilitate the risk compliance implementation by selecting/controlling acceptable risk levels and the like. Thus, this instance of the risk driven compliance system 200 provides a risk compliance system that can be implemented in conjunction with an existing compliance engine to provide dynamic risk compliance in response to the risk level 204. In one instance, scripts are utilized by the risk driven compliance component 202 to control a compliance engine as risk levels change.

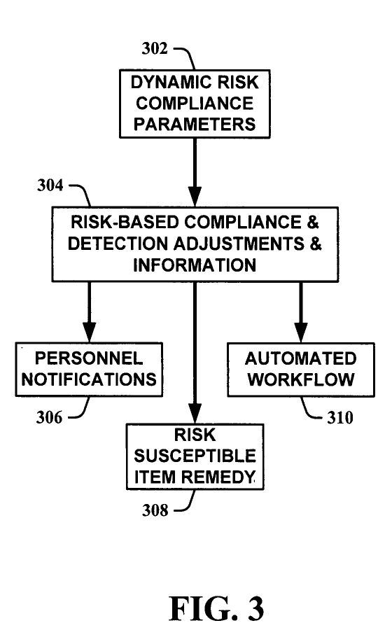

FIG. 3 illustrates an example 300 of dynamic risk compliance parameters 302 in accordance with an aspect of an embodiment. In this instance, the dynamic risk compliance parameters 302 include, but are not limited to, risk-based compliance and detection adjustments and information 304. The risk-based compliance and detection adjustments and information 304 can include, for example, personnel notifications 306, risk susceptible item remedy 308, and/or automated workflow 310 and the like. The personnel notifications 306 can include, but are not limited to, email notifications, instant messaging (IM) notifications, text messaging, paging, visual alerts, audible alerts, at-risk personnel notifications, and/or system-wide notifications and the like. The risk susceptible item remedy 308 can include, but is not limited to, increased detection levels for a computing device, shutdown of a computing device, installation of additional protection elements on and/or for a computing device, taking a computing device ‘off-line,’ and/or rebooting a computing device and the like. The automated workflow 310 can include, but is not limited to, workflows that provide a user with protection steps for an entire environment and/or a specific item of an environment and the like. The automated workflow 310 can also be a preventive and/or a remedial workflow and the like. The risk-based compliance and detection adjustments and information 304 can also include other information such as, for example, reports and/or suggestions that can be utilized in real-time and/or stored for future analysis and/or comparisons (e.g., baseline reports can be created to facilitate in detecting future anomalies, etc.).

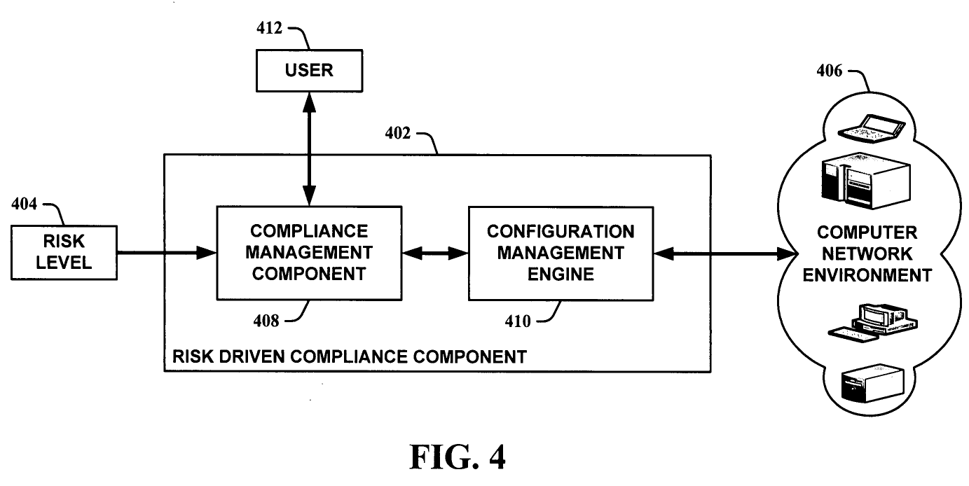

Referring to FIG. 4, a block diagram of a risk driven compliance system 400 interacting with a computer network environment in accordance with an aspect of an embodiment is shown. The risk driven compliance system 400 is comprised of a risk driven compliance component 402 that obtains a risk level 404 and interfaces with a computer network environment 406. The risk driven compliance component 402 is comprised of a compliance management component 408 that interfaces with a user 412 and a configuration management engine 410. In this example, the compliance management component 408 obtains the risk level 404 directly. It 408 also provides a user interface so that it 408 can interact with the user 412 to provide information and/or to receive control information and the like. The compliance management component 408 utilizes the risk level 404 and/or user supplied information from the user 412 to dynamically determine risk compliance issues and management solutions for those issues (e.g., increased detection levels, remedial actions, etc.) for the computer network environment 406. The configuration management engine 410 (described in detail infra) receives the solutions from the compliance management component 408 and implements them on the computer network environment 406 to bring it 406 into compliance. In this manner, the risk driven compliance system 400 dynamically responds to changing risk levels and actively adjusts compliance parameters in response to the risk level 404.

In other instances of the risk driven compliance system 400, the configuration management engine 410 can directly receive the risk level 404 and dynamically implement compliance adjustments on the computer network environment 406. For example, the configuration management engine 410 can contain discrete risk level scripts that have been programmed to bring the computer network environment 406 into compliance. In this simplistic approach, the configuration management engine 410 automatically runs the appropriate script based on the risk level 404.

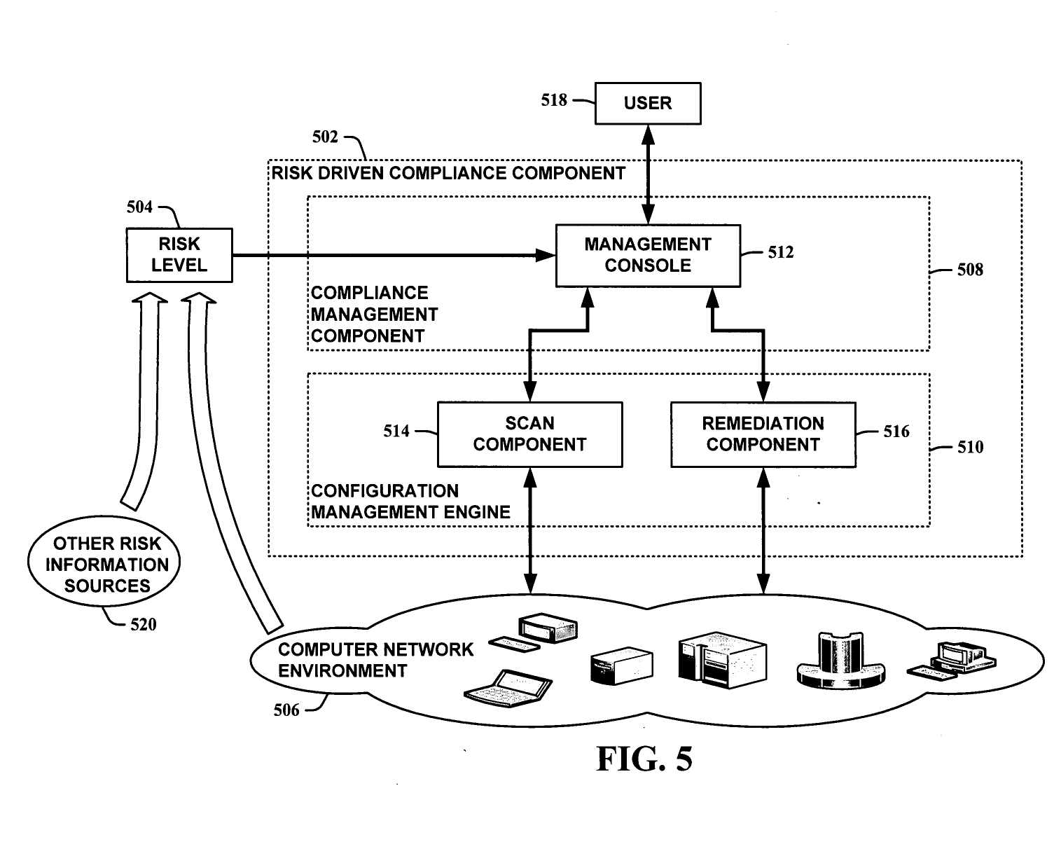

Moving on FIG. 5, another block diagram of a risk driven compliance system 500 interacting with a computer network environment 506 in accordance with an aspect of an embodiment is depicted. The risk driven compliance system 500 is comprised of a risk driven compliance component 502 that obtains a risk level 504 and interfaces with a computer network environment 506. The risk level 504 can be based on threats to the computer network environment 506 and/or derived from and/or obtained from other risk information sources 520. The risk driven compliance component 502 is comprised of a compliance management component 508 and a configuration management engine 510. The compliance management component 508 is comprised of a management console 512. The configuration management engine 510 is comprised of a scan component 514 and a remediation component 516.

The management console 512 obtains the risk level 504 and determines compliance management actions necessary in response to it 504. The required actions can include, for example, control information obtained from a user 518 with regard, for example, to acceptable levels of risk and/or remediation and/or detection actions and the like. In one instance, the management console 512 formulates scripts and/or employs pre-existing scripts to adjust detection/scanning levels and/or remediation actions and the like in response to the risk level 504. For example, the scan component 514 can include a scan model that employs a scan script from the management console 512 and scans the computer network environment 506 accordingly. In a similar fashion, the remediation component 516 can include a remediation model that employs the remediation script from the management console 512 and initiates remedies on the computer network environment 506 accordingly. An example architecture that employs scripting is discussed in detail infra. This affords substantial flexibility in implementing the risk driven compliance system 500 into existing systems and the like. This dramatically improves risk compliance as discussed below.

Risk Driven Compliance Management

Scanning an enterprise environment for security risks is a complex and time consuming task. The more scans and checks that are performed ensure that a higher number of “false positives” are detected. Each of these false positives may require additional investigation. Additionally, as the risk level of an environment is increased, different mitigations may be required by the administrators. Mitigations are typically sparingly applied because they often have undesirable side effects (e.g., loss of services, loss of functionality, destabilization of machines, etc.). Thus, typically, higher level mitigations are automatically enacted only in times when the increased level of risk demands it. On a day-to-day basis, administrators may want to simply be notified of machines that do not meet security requirements on their network, but in times of high risk, it may be desirable to completely isolate these same machines from the rest of the network to limit the exposure to identified threats.

To accomplish this, instances of the systems and methods herein can utilize, for example, a compliance management component (e.g., can include a management user interface such as a management console) and/or a configuration management engine. The compliance management component can be a centralized point of administration that allows an organization to review a state of compliance, for example, with security policy across the environment and/or select a current level of risk which can drive the configuration management engine appropriately. Additionally, the compliance management component can provide the ability to add new policies to monitor and/or define remediation steps given the different levels of risk.

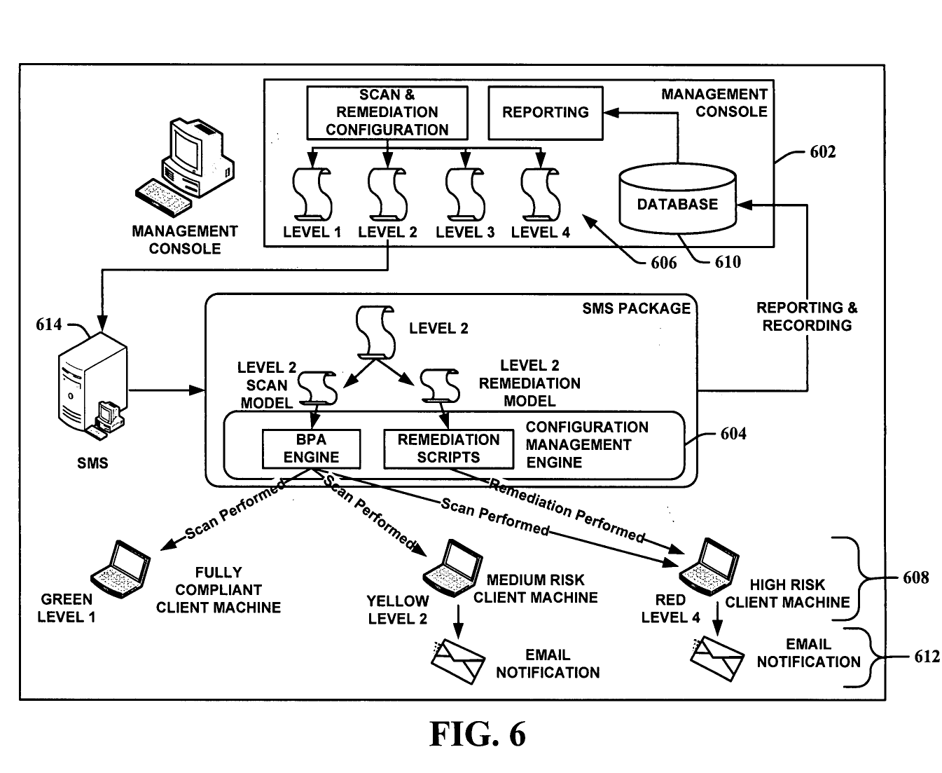

In FIG. 6, an illustration of an example system architecture for a risk driven compliance system 600 in accordance with an aspect of an embodiment is shown. The risk driven compliance system 600 is comprised of a management console 602 and a configuration engine 604. This example is illustrative of a typical use scenario for the systems and methods herein which can include, but are not limited to, the following:
1) The management console (i.e., compliance management component) 602 is installed and configured into the environment. During this time, network system administrators can evaluate an existing security policy and determine if any changes need to be made to default risk level configurations 606. The changes can include the addition of new scans, modifications of scans performed at different risk levels and/or remediation performed at different risk levels. Typically, there are four levels of risk defined—each with different associated configuration checks and/or remediation actions.
   Level 1 (Green):
   Configuration Checks—At this level, a minimum set of checks is generally performed. This can include checking patch levels against a recommended baseline, ensuring that all anti-malware software is up-to-date and enabled, and/or verifying that a firewall is enabled and configured correctly.
   Remediation—The only remediation typically made at this level is the update of the anti-malware software. However, if a computing device 608 fails the checks for patch level and/or firewall, it can be recorded in a database 610 and the information can be reported on, for example, the management console 602.
   Frequency—A scan can be performed, for example, once every 24 hours.
      Level 2 (Yellow):
   Configuration Checks—The checks at this level can include everything from the previous level, but also looks for additional information such as, for example, weak user passwords, client machines with potentially extraneous services (IIS, SQL), enabled anonymous access, and/or file shares with weak/no permissions and the like.
   Remediation—Patches may be automatically applied. Other items can be reported on, for example, the management console 602. If the checks, for example, for weak passwords and/or weak file share permissions are detected, an email 612 can be generated to a computing device owner and/or to a security operations staff that identifies the computing device 608 as a potential risk.
   Frequency—A scan can be performed, for example, once every 12 hours.
      Level 3 (Orange):
   Configuration Checks—The checks at this level can include everything from the previous level, but, for example, it can also look for known attack tools, and/or evaluate user accounts against database information to determine if any new accounts have been added and the like. Anti-malware programs, for example, can be forced to run a full scan. Web browser settings, for example, can be evaluated.
   Remediation—The firewall, for example, can be automatically enabled. User accounts with weak passwords, for example, can be disabled and/or anonymous access can be denied unless a computing device 608 has a specific exception defined in the system and the like. Other items can be reported, for example, on the management console 602. If potential attack tools are detected and/or malware is detected, an email 612, for example, can be generated to a computing device owner and/or to a security operations staff that identifies a computing device 608 as a high risk. Computing devices 608 that are not managed (e.g., no administrator access) can be, for example, documented and/or emailed directly to a security operations team. These can be, for example, programmatically disconnected from a network (e.g., by a network operations team) and/or manually addressed.
   Frequency —A scan can be performed, for example, once every 8 hours.
      Level 4 (Red):
   Configuration Checks—No additional checks are typically performed at this level, but additional ones could be added based on the needs of the network maintainer.
   Remediation—Failing one of the above checks can result, for example, in a computing device 608 being disconnected from a network through the use of, for example, IPsec filters and/or manually, for example, through configuration of a virtual switch. It generally can only be re-enabled by a network administrator and the like.
   Frequency—A scan can be performed, for example, once every 8 hours. Additionally, a system can be flexible enough that an administrator can enable all scans to be performed each time, and only the level of remediation and reporting changes.
2) The administrator evaluates security threats in/to the environment. If no high risk threats are identified (e.g., viruses on the network, DOS attacks on the external presence, worm outbreaks, attack patterns on external facing machines, etc.), they can configure the management console 602 to show a risk level of, for example, Level 1 (Green).
3) The management console 602 can initiate a scan of computing devices 608 in its scope. This can include, for example, workstations, laptops, servers, and/or mobile devices and the like. During a first scan, it 602 can record, for example, pertinent machine information such as, for example, name, MAC address, IP address, and/or operating system and the like into the database 610. If it is a managed machine, it 602 can also record, for example, the users in an administrator's group of a computing device 608 and then complete, for example, an equivalent of a level 4 scan, but only perform a level 1 remediation. Doing this provides a baseline for the environment and can allow an administrator to proactively begin addressing more complex issues.
4) When a scan is completed, the results can be displayed on the management console 602 compared to a selected risk level (e.g., level 1). The management console 602 can allow an administrator to view computing devices 608, for example, in an organization based on user-defined groups (e.g., departments, etc.), subnets, and/or violation type (failed patch level check) and the like.
5) Computing devices 608 can be re-scanned, for example, every 24 hours and/or until a risk level is changed.
6) Once an administrator determines there is a higher risk in/to a network environment, they can adjust the risk level on the management console 602. Immediately after confirmation, for example, a scan can be initiated based on the level selected. Additionally, a full scan (e.g., equivalent to the level 4 scan) can be performed, for example, once a week to update the baseline in the database 610.
   Compliance Management Component

The compliance management component (e.g., management console 602) can be installed and configured, for example, in a central location of a network environment. The compliance management component can provide, for example, a point of administration for a scan and/or remediation process and/or provide a “dashboard” view of an entire network environment. For example, the management console 602 can singularly manage the scanning of a large number of client computers and/or manage several sub-management consoles that each manages the scanning of groups of computers. This distributed management allows for regional evaluation and/or analysis of compliance levels. The rules governing risk levels are configurable such that, for example, either sub-management consoles can be automatically overridden by a risk level selected on a central console and/or a highest risk level anywhere in the network environment is automatically adopted by other consoles. The management console 602 can utilize an existing software deployment technology that is already deployed in a network environment such as, for example, SMS (Systems Management Server) 614 to actually schedule and/or perform the scans on the individual client computers.

Configuration Management Engine

The configuration management engine 604 can utilize direct input from the console and/or be a model driven scan and/or remediation engine. This means that at any point, the configuration management engine 604 can consume one of multiple different models that use, for example, XML (eXtensible Markup Language) to describe a scan to be performed, the expected value, and/or a remediation action to occur and the like. Typically, a schema is employed with a modeling language that can identify both scans and remediations and the like.

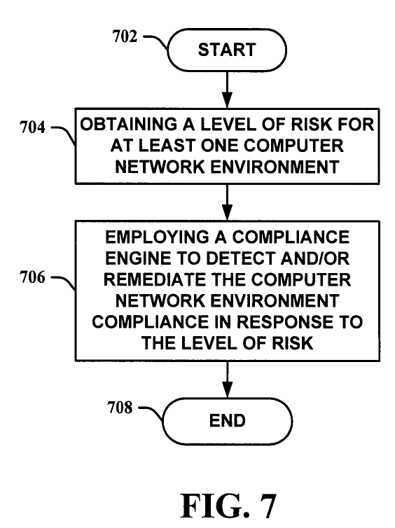

In view of the exemplary systems shown and described above, methodologies that may be implemented in accordance with the embodiments will be better appreciated with reference to the flow charts of FIGS. 7-9. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 7, a flow diagram of a method 700 of facilitating risk driven compliance in accordance with an aspect of an embodiment is shown. The method 700 starts 702 by obtaining a level of risk for at least one computer network environment 704. The level of risk can be obtained directly from a risk assessing source and/or wholly and/or partially derived based on computer network environmental factors, business, security, and/or other parameters (e.g., input from an intrusion detection system (IDS), etc.). A compliance engine is then employed to detect and/or remediate the computer network environment compliance in response to the level of risk 706, ending the flow 708. In this instance the compliance engine directly responds to the risk level to implement necessary actions to bring the computer network environment into compliance. This can include, but is not limited to, increasing detection levels, taking remedial actions on the environment as a whole and/or on individual items of the environment and the like in response to the risk level. The individual items can include, but are not limited to, servers, desktop computers, mainframes, laptops, and/or mobile devices and the like. In this manner, risk driven compliance can be implemented, for example, with predetermined scripts and the like without necessarily requiring additional risk compliance management devices and the like.

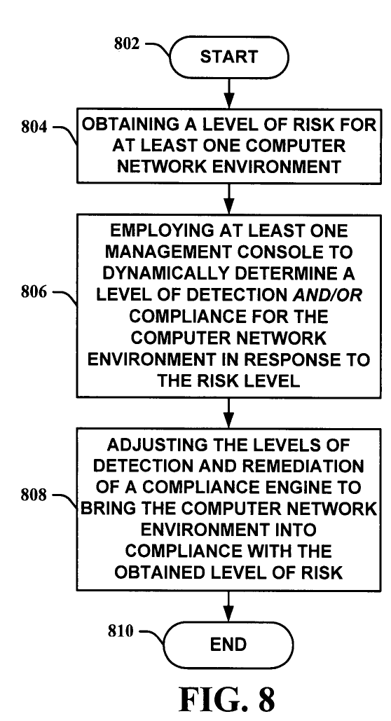

Turning to FIG. 8, another flow diagram of a method 800 of facilitating risk driven compliance in accordance with an aspect of an embodiment is depicted. The method 800 starts 802 by obtaining a level of risk for at least one computer network environment 804. As described above, the risk level can be obtained in whole or in part, directly and/or indirectly from various sources. At least one management console is employed to dynamically determine a level of detection and/or compliance for the computer network environment in response to the risk level 806. The management console can derive its determination based solely on the risk level or in conjunction with user determined inputs (e.g., acceptable risk levels, acceptable remedial actions, etc.) and the like. The levels of detection and remediation of a compliance engine are then adjusted to bring the computer network environment into compliance with the obtained level of risk 808, ending the flow 810. Compliance can be achieved by implementing adjustments to an entire environment and/or to an individual item (e.g., laptop, server, etc.) of the environment. Compliance can be achieved by utilizing the compliance engine in conjunction with user implemented (e.g., manual) changes as well.

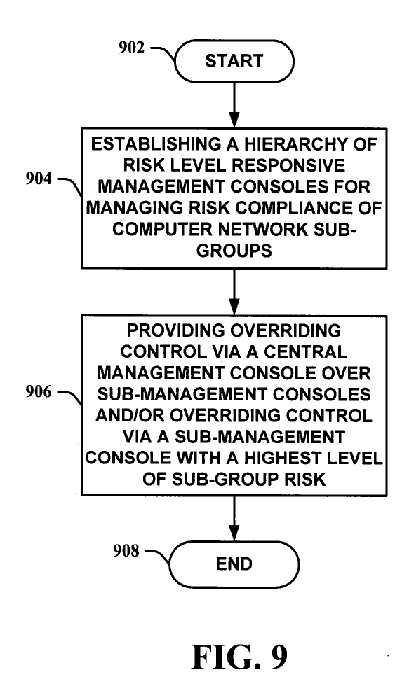

Looking at FIG. 9, yet another flow diagram of a method 900 of facilitating risk driven compliance in accordance with an aspect of an embodiment is illustrated. The method 900 starts 902 by establishing a hierarchy of risk level responsive management consoles for managing risk compliance of computer network sub-groups 904. The hierarchy typically includes a central management console that ‘oversees’ additional sub-management consoles. This allows a single source for compliance information while still affording substantially flexibility by having sub-management consoles that can be individually tailored for risk levels of individual environments and/or computing sub-groups. Overriding control via a central management console over sub-management consoles and/or overriding control via a sub-management console with a highest level of sub-group risk is then provided 906, ending the flow 908. Thus, the central management console can have ultimate control over all sub-management consoles so that dynamic responses to its risk level can be implemented over some or all of the computing devices. However, if the administrator desires, a sub-management console can be granted the ability to dynamically implement compliance tasks if it receives a level of risk higher than other management consoles. The central administrator can be notified of this change to the sub-management console and can adjust the overall level of risk in the environment if desired. This facilitates to ensure that all computing devices have protection against the most dangerous threat present against the environment.

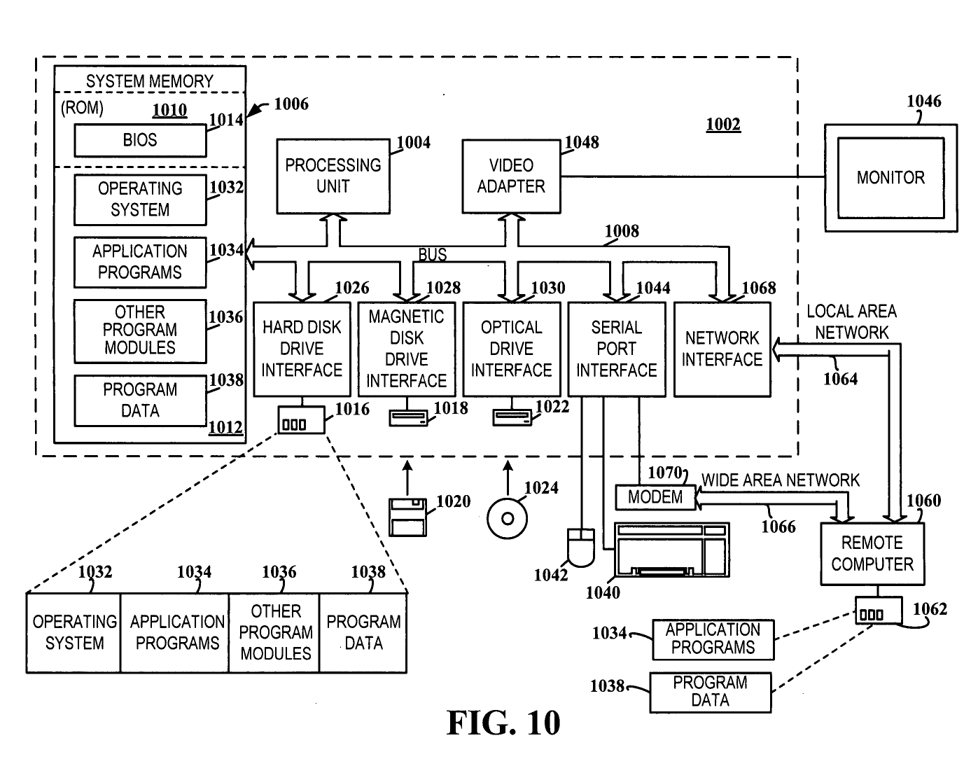

In order to provide additional context for implementing various aspects of the embodiments, FIG. 10 and the following discussion is intended to provide a brief, general description of a suitable computing environment 1000 in which the various aspects of the embodiments may be implemented. While the embodiments have been described above in the general context of computer-executable instructions of a computer program that runs on a local computer and/or remote computer, those skilled in the art will recognize that the embodiments may also be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the embodiments may also be practiced in distributed computing environments where certain tasks are performed by remote processing devices that are linked through a communications network. However, some, if not all, aspects of the embodiments may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

With reference to FIG. 10, an exemplary system environment 1000 for implementing the various aspects of the embodiments include a conventional computer 1002, including a processing unit 1004, a system memory 1006, and a system bus 1008 that couples various system components, including the system memory, to the processing unit 1004. The processing unit 1004 may be any commercially available or proprietary processor. In addition, the processing unit may be implemented as multi-processor formed of more than one processor, such as may be connected in parallel.

The system bus 1008 may be any of several types of bus structure including a memory bus or memory controller, a peripheral bus, and a local bus using any of a variety of conventional bus architectures such as PCI, VESA, Microchannel, ISA, and EISA, to name a few. The system memory 1006 includes read only memory (ROM) 1010 and random access memory (RAM) 1012. A basic input/output system (BIOS) 1014, containing the basic routines that help to transfer information between elements within the computer 1002, such as during start-up, is stored in ROM 1010.

The computer 1002 also may include, for example, a hard disk drive 1016, a magnetic disk drive 1018, e.g., to read from or write to a removable disk 1020, and an optical disk drive 1022, e.g., for reading from or writing to a CD-ROM disk 1024 or other optical media. The hard disk drive 1016, magnetic disk drive 1018, and optical disk drive 1022 are connected to the system bus 1008 by a hard disk drive interface 1026, a magnetic disk drive interface 1028, and an optical drive interface 1030, respectively. The drives 1016-1022 and their associated computer-readable media provide nonvolatile storage of data, data structures, computer-executable instructions, etc. for the computer 1002. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 1000, and further that any such media may contain computer-executable instructions for performing the methods of the embodiments.

A number of program modules may be stored in the drives 1016-1022 and RAM 1012, including an operating system 1032, one or more application programs 1034, other program modules 1036, and program data 1038. The operating system 1032 may be any suitable operating system or combination of operating systems. By way of example, the application programs 1034 and program modules 1036 can include a computer network environment compliance scheme in accordance with an aspect of an embodiment.

A user can enter commands and information into the computer 1002 through one or more user input devices, such as a keyboard 1040 and a pointing device (e.g., a mouse 1042). Other input devices (not shown) may include a microphone, a joystick, a game pad, a satellite dish, a wireless remote, a scanner, or the like. These and other input devices are often connected to the processing unit 1004 through a serial port interface 1044 that is coupled to the system bus 1008, but may be connected by other interfaces, such as a parallel port, a game port or a universal serial bus (USB). A monitor 1046 or other type of display device is also connected to the system bus 1008 via an interface, such as a video adapter 1048. In addition to the monitor 1046, the computer 1002 may include other peripheral output devices (not shown), such as speakers, printers, etc.

It is to be appreciated that the computer 1002 can operate in a networked environment using logical connections to one or more remote computers 1060. The remote computer 1060 may be a workstation, a server computer, a router, a peer device or other common network node, and typically includes many or all of the elements described relative to the computer 1002, although for purposes of brevity, only a memory storage device 1062 is illustrated in FIG. 10. The logical connections depicted in FIG. 10 can include a local area network (LAN) 1064 and a wide area network (WAN) 1066. Such networking environments are commonplace in offices, enterprise-wide computer networks, intranets and the Internet.

When used in a LAN networking environment, for example, the computer 1002 is connected to the local network 1064 through a network interface or adapter 1068. When used in a WAN networking environment, the computer 1002 typically includes a modem (e.g., telephone, DSL, cable, etc.) 1070, or is connected to a communications server on the LAN, or has other means for establishing communications over the WAN 1066, such as the Internet. The modem 1070, which can be internal or external relative to the computer 1002, is connected to the system bus 1008 via the serial port interface 1044. In a networked environment, program modules (including application programs 1034) and/or program data 1038 can be stored in the remote memory storage device 1062. It will be appreciated that the network connections shown are exemplary and other means (e.g., wired or wireless) of establishing a communications link between the computers 1002 and 1060 can be used when carrying out an aspect of an embodiment.

In accordance with the practices of persons skilled in the art of computer programming, the embodiments have been described with reference to acts and symbolic representations of operations that are performed by a computer, such as the computer 1002 or remote computer 1060, unless otherwise indicated. Such acts and operations are sometimes referred to as being computer-executed. It will be appreciated that the acts and symbolically represented operations include the manipulation by the processing unit 1004 of electrical signals representing data bits which causes a resulting transformation or reduction of the electrical signal representation, and the maintenance of data bits at memory locations in the memory system (including the system memory 1006, hard drive 1016, floppy disks 1020, CD-ROM 1024, and remote memory 1062) to thereby reconfigure or otherwise alter the computer system's operation, as well as other processing of signals. The memory locations where such data bits are maintained are physical locations that have particular electrical, magnetic, or optical properties corresponding to the data bits.

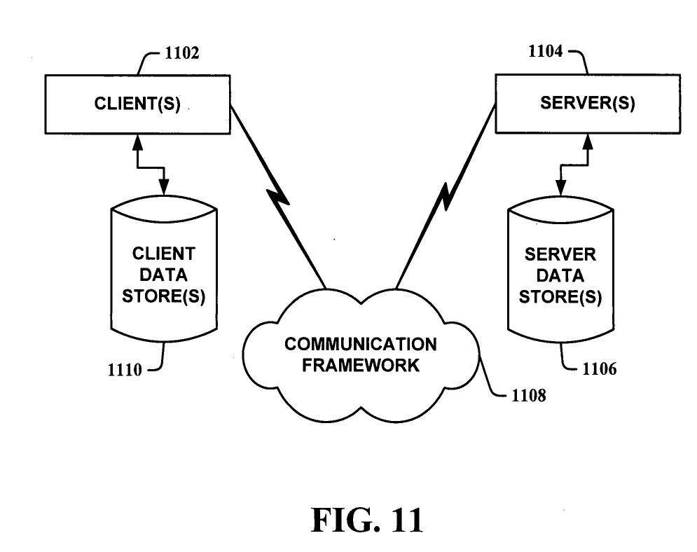

FIG. 11 is another block diagram of a sample computing environment 1100 with which embodiments can interact. The system 1100 further illustrates a system that includes one or more client(s) 1102. The client(s) 1102 can be hardware and/or software (e.g., threads, processes, computing devices). The system 1100 also includes one or more server(s) 1104. The server(s) 1104 can also be hardware and/or software (e.g., threads, processes, computing devices). One possible communication between a client 1102 and a server 1104 may be in the form of a data packet adapted to be transmitted between two or more computer processes. The system 1100 includes a communication framework 1108 that can be employed to facilitate communications between the client(s) 1102 and the server(s) 1104. The client(s) 1102 are connected to one or more client data store(s) 1110 that can be employed to store information local to the client(s) 1102. Similarly, the server(s) 1104 are connected to one or more server data store(s) 1106 that can be employed to store information local to the server(s) 1104.

It is to be appreciated that the systems and/or methods of the embodiments can be utilized in computer network environment compliance facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that ensures computer network environment compliance, comprising:
a receiving component that obtains a level of risk for at least one computer network environment; and
a compliance management component that dynamically determines a level of detection and/or compliance for the computer network environment in response to the risk level.

2. The system of claim 1, the compliance management component automatically facilitates in remedying at least one risk susceptible item based on the risk level.

3. The system of claim 1, the compliance management component notifies personnel of at least one change to facilitate in manually remedying at least one risk susceptible item.

4. The system of claim 1, the compliance management component provides personnel with an automated workflow to facilitate in remedying at least one risk susceptible item.

5. The system of claim 1 is responsive to levels of risk based on, at least in part, business, security, and/or operational information.

6. The system of claim 1 further comprising:
a management console that provides a user interface to allow a user to control at least one level of response for at least one risk level and/or to obtain information regarding compliance information obtained by the compliance management component.

7. The system of claim 6, the management console comprising a hierarchy of a central management console and at least one sub-management console that provides compliance management for a respective sub-group of computing devices.

8. The system of claim 7, the central management console providing overriding risk level control of at least one sub-management console and/or allowing overriding risk level control by at least one sub-management console reporting a highest level of risk.

9. The system of claim 1 further comprising:
a configuration management engine that facilitates in scanning and/or remediation of the computer network environment to facilitate the compliance management component in dynamically responding to the risk level to maintain detection and/or compliance of the computer network environment.

10. The system of claim 9, the configuration management engine comprising a scriptable scan model and/or a scriptable remediation model.

11. A method for ensuring computer network environment compliance, comprising:
obtaining a level of risk for at least one computer network environment; and
employing a compliance engine to detect and/or remediate the computer network environment compliance in response to the level of risk.

12. The method of claim 11 further comprising:
dynamically determining a level of detection and/or compliance for the computer network environment in response to the risk level; and
adjusting the levels of detection and/or remediation for the computer network environment into compliance with the obtained level of risk.

13. The method of claim 11 further comprising:
providing a centralized point of administration for reviewing a state of compliance and/or selecting a level of risk for compliance related tasks.

14. The method of claim 11 further comprising:
automatically remedying at least one risk susceptible item based on the risk level.

15. The method of claim 11 further comprising:
notifying at least one user of at least one change to facilitate in manually remedying at least one risk susceptible item.

16. The method of claim 11 further comprising:
responding to levels of risk based on, at least in part, business, security, and/or operational information.

17. The method of claim 11 further comprising:
providing a user interface to control at least one level of response for at least one risk level and/or to obtain information regarding compliance information obtained by the compliance management component.

18. The method of claim 17 further comprising:
providing a compliance management hierarchy for sub-groups of at least one computer network with overriding risk level control via a sub-group manager with a highest risk level and/or overriding risk level control via a central manager regardless of level of risk.

19. A system that ensures computer network environment compliance, comprising:
means for obtaining a level of risk for at least one computer network environment;
means for dynamically determining a level of detection and compliance for the computer network environment in response to the risk level; and
means for scanning and/or remediation of the computer network environment to facilitate in dynamically responding to the risk level to maintain detection and/or compliance of the computer network environment.

20. A device employing the system of claim 1 comprising at least one selected from the group consisting of a computer, a server, and a handheld electronic device.
